(19) United States
(12) Patent Application Publication
(10) Pub. No.: US 2008/0234398 A1
(43) Pub. Date: Sep. 25, 2008

(54) Monodisperse weakly acidic cation exchangers

(76) Inventors: Reinhold Klipper, Koln (DE); Wolfgang Podszun, Munchen (DE); Michael Schelhaas, Koln (DE); Pierre Vanhoorne, Monheim (DE); Hans-Karl Soest, Koln (DE); Ulrich Litzinger, Hachenburg (DE)

Correspondence Address: LANXESS CORPORATION, 111 RIDC PARK WEST DRIVE, PITTSBURGH, PA, 15275-1112, US

(21) Appl. No.: 12/070,442

(22) Filed: Feb. 19, 2008

(30) Foreign Application Priority Data
Feb. 24, 2007 (DE) 10 2007 009 072.4

(51) Int. Cl. B01J 39/20

(52) U.S. Cl. 521/31

(57) ABSTRACT

The present invention relates to a process for producing novel monodisperse cation exchangers of the poly(meth)acrylic acid type, the ion exchangers themselves, and also use thereof and to the use of intermediate products as supports for enzymes and the systems resulting therefrom as enzyme catalysts for the preparation of fuels and in transesterification reactions and esterification reactions.

The present invention relates to a process for preparing monodisperse cation exchangers of the poly(meth)acrylic acid type and also applications thereof and to the use of the intermediate products resulting from the synthesis as carriers for enzymes and to the use thereof as enzyme catalysts for the preparation of combustion fuels and in transesterification reactions and esterification reactions.

### BACKGROUND OF THE INVENTION

From the prior art, heterodisperse cation exchangers of the poly(meth)acrylic acid type are already known. These are a class of cation exchangers which can be used in practice for numerous different applications.

An important area of use of heterodisperse cation exchangers of the poly(meth)acrylic acid type is in water treatment technology, in which it is possible to remove polyvalent cations, for example calcium, magnesium, lead or copper, but also carbonate anions.

A known process for preparing heterodisperse cation exchangers of the poly(meth)acrylic acid type is hydrolysis of crosslinked bead polymers of (meth)acrylic monomers using acids or alkalis according to DE 10 322 441 A1 (US=2005 090 621 A1), DD 67583 or U.S. Pat. No. 5,369,132.

The crosslinked (meth)acrylic ester or (meth)acrylonitrile resin bead polymers used for the hydrolysis are prepared in the prior art as gel-type or macroporous resins. They are prepared by mixed polymerization using the suspension polymerization process. This produces heterodisperse bead polymers having a broad particle size distribution in the range of approximately 0.2 mm to approximately 1.2 mm.

The heterodisperse cation exchangers of the poly(meth)acrylic acid type, depending on the charged form of the resin, that is to say depending on the type of counterion, exhibit differing resin volumes. In the conversion from the free acid form to the sodium form, the resin swells markedly. Conversely, on conversion from the sodium form to the free acid form, it shrinks. In the industrial use of these heterodisperse cation exchangers of the poly(meth)acrylic acid type, therefore, each charging and regeneration is associated with swelling or shrinkage. In the course of long-term use, however, these heterodisperse cation exchangers are regenerated several hundred times. The shrinking and swelling operations occurring as this is done stress the bead stability so greatly that a fraction of the beads acquire cracks, finally even fracturing. Fragments are produced which lead to blockages in the service apparatus, the columns, impede flow, which in turn leads to an increased pressure drop. In addition, the fragments contaminate the medium to be treated, preferably water, and thus reduce the quality of the medium or the water.

The flow of water through a column packed with beads, however, is impeded not only by resin fragments, but also by fine polymer beads. A rise in the pressure drop occurs. Owing to the particle size distribution, however, a heterodisperse cation exchanger of the poly(meth)acrylic acid type contains beads of differing diameter. The presence of fine beads thus additionally increases the pressure drop.

After completion of charging of cation exchangers of the poly(meth)acrylic acid type with cations, the resin is regenerated with dilute hydrochloric acid in order to be ready for new charging. Hydrochloric acid residues are washed out of the resin with water. During production of the resins a low conductivity of the effluent water (washwater) from the resin is desired, since otherwise contaminated water is present. The aim is to achieve low conductivities using small amounts of washwater.

To decrease the pressure drop and to improve the extractability, therefore, the use of cation exchangers of the poly(meth)acrylic acid type with narrow particle size distribution is desirable.

Such narrow particle size distribution cation exchangers of the poly(meth)acrylic acid type in the range of 30 to 500 μm are customarily obtained by fractionating cation exchangers of the poly(meth)acrylic acid type having a wide particle size distribution. A disadvantage in this process is that with increasing monodispersity the yield of the desired target fraction in the fractionation decreases greatly. The mechanical and osmotic stability of the cation exchangers thus obtained is not improved either.

DE 10 237 601 A1 (=WO 2004 022 611 A1) discloses monodisperse gel-type ion exchangers having a diameter of up to 500 μm which are prepared from monodisperse gel-type bead polymers which contain 50 to 99.9% by weight of styrene and, as comonomers, copolymerizable compounds, such as e.g. methyl methacrylate, ethyl methacrylate, ethyl acrylate, hydroxyethyl methacrylate or acrylonitrile. In the process according to DE 10 237 601 A1, use is made of uncrosslinked seed polymers. After hydrolysis of the monodisperse gel-type bead polymers, cation exchangers are obtainable which have functional groups of the poly(meth)acrylic acid type. Owing to the high content of non-functional styrene, the total capacity (number of functional groups per unit volume of resin in eq./litre) of such cation exchangers is limited and insufficient for most applications.

Starting from the prior art, the object of the present invention was to provide cation exchangers of the poly(meth)acrylic acid type having high mechanical stability and also osmotic stability of the beads, low pressure drop of the bead bed in use and also low washwater consumption of the cation exchanger itself.

### SUMMARY OF THE INVENTION

The present invention and solution of this object therefore relate to a process for preparing cation exchangers of the poly(meth)acrylic acid type, characterized in that
a) encapsulated, bead-type monomer drops are prepared in a continuous, preferably aqueous phase and this phase is heated, where appropriate, to temperatures ≧50° C., at which polymerization may take place,
b) these encapsulated bead-type monomer drops are admixed with mixtures of (meth)acrylic monomers, crosslinkers, initiators and optionally porogens, optionally under polymerization conditions, wherein the mixture penetrates into the encapsulated drops and, in the case of addition under polymerization conditions, polymerizes,
c) the encapsulated drops are polymerized at elevated temperature, and
d) the resultant crosslinked (meth)acrylic bead polymer is hydrolysed with acids or alkalis to give a crosslinked, bead polymer of the poly(meth)acrylic acid type.

In a variant embodiment of the present invention, steps b) and c) can be repeated once or several times. If the procedure followed in step a) is such that the mixture is heated to temperatures of ≧50° C. and components are added in step b) under polymerization conditions, what are termed in situ seed/feed processes are spoken of.

Characteristic of the in situ seed/feed process is addition of the monomers/monomer mixture to the encapsulated monomer drops under polymerization conditions.

The encapsulated bead-type monomer drops to be used in step a) are preferably used in monodisperse form, or in a particle size distribution for which they are generated by combination of jetting and microencapsulation.

As a measure of the width of the particle size distribution of the inventive monodisperse cation exchangers of the (meth)acrylic acid type, the ratio of the 90% value (Ø(90)) and the 10% value (Ø(10)) of the volume distribution is formed. The 90% value (Ø(90)) is the diameter which 90% of the particles fall below. Correspondingly, 10% of the particles fall below the diameter of the 10% value (Ø(10)). Monodisperse particle size distributions in the context of the present application denote Ø(90)/Ø(10)≦1.5, preferably Ø(90)/Ø(10)≦1.25.

Cation exchangers according to the invention of the poly(meth)acrylic acid type are weakly acidic and contain polymerized units of acrylic acid or methacrylic acid.

Preference in accordance with the invention is given to methods in which the monodispersity is established in the production process itself. In the atomization process, or in “jetting”, a monomer mixture consisting of one or more different vinyl monomer(s) and also one or more crosslinker(s), and one or more initiator(s) is sprayed into a liquid which is essentially immiscible with the monomer mixture, droplets of uniform particle size being formed. By employing a longitudinal oscillation of suitable frequency, the formation of monodisperse droplets can be supported. The oscillation excitation can be achieved by the action of periodic pressure fluctuations, such as sound waves. Further details on oscillation excitation are described in EP 0 046 535 A2.

In accordance with the present invention, the monodisperse droplets produced by atomization and/or oscillation excitation are microencapsulated. In this manner it is possible to produce bead polymers having particularly high monodispersity.

For encapsulation of the monomer droplets, also referred to as microencapsulation, the materials known for use as complex coacervates preferably come into consideration, in particular polyesters, natural or synthetic polyamides, polyurethanes, polyureas.

As a natural polyamide, gelatin, for example, is particularly highly suitable. This is used in particular as a coacervate or complex coacervate. Gelatin-containing complex coacervates within the context of the invention are taken to mean, especially, combinations of gelatin with synthetic polyelectrolytes. Suitable synthetic polyelectrolytes are copolymers having incorporated units of, for example, maleic acid, acrylic acid, methacrylic acid, acrylamide or methacrylamide. Particularly preferably, acrylic acid or acrylamide is used. Gelatin-containing capsules can be hardened using conventional hardening agents such as, for example, formaldehyde or glutaraldehyde. The encapsulation of monomer droplets via gelatin, gelatin-containing coacervates and gelatin-containing complex coacervates is described in detail in EP 0 046 535 A3. The methods of encapsulation using synthetic polymers are known. Phase boundary condensation is highly suitable, for example, in which a reactive component (for example an isocyanate or an acid chloride) dissolved in the monomer droplet is reacted with a second reactive component (for example an amine) dissolved in the aqueous phase.

The encapsulated bead-type monomer drops from process step a) can contain essentially a mixture of monoethylenically unsaturated compounds, a polyvinylaromatic compound, one or more initiators and optionally one or more porogens.

As monoethylenically unsaturated compounds, preferably use is made of styrene, vinyltoluene, ethylstyrene, α-methylstyrene, chlorostyrene, chloromethylstyrene, (meth)acrylic acid, (meth)acrylonitrile, acrylic alkyl esters and methacrylic alkyl esters.

(Meth)acrylic esters are taken to mean the esters of acrylic acid and methacrylic acid. Use may preferably be made of ethyl acrylate, methyl acrylate, n-butyl acrylate, t-butyl acrylate, 2-ethylhexyl acrylate, benzyl acrylate, ethyl methacrylate, methyl methacrylate, n-butyl methacrylate, t-butyl methacrylate, 2-ethylhexyl methacrylate or n-hexyl methacrylate. Methyl methacrylate, n-butyl methacrylate and methyl acrylate are most preferably used.

The encapsulated bead-type monomer drops from process step a) preferably contain 0.05 to 80% by weight, most preferably 0.1 to 30% by weight, of crosslinker. Suitable crosslinkers for the crosslinked bead polymers are multifunctional ethylenically unsaturated compounds, preferably butadiene, isoprene, divinylbenzene, divinyltoluene, trivinylbenzene, divinylnaphthalene, trivinylnaphthalene, divinylcyclohexane, trivinylcyclohexane, triallyl cyanurate, triallylamine, 1,7-octadiene, 1,5-hexadiene, cyclopentadiene, norbornadiene, diethylene glycol divinyl ether, triethylene glycol divinyl ether, tetraethylene glycol divinyl ether, butanediol divinyl ether, ethylene glycol divinyl ether, cyclohexanedimethanol divinyl ether, hexanediol divinyl ether or trimethylolpropane trivinyl ether. In particular, divinylbenzene (DVB) is suitable in many cases. Commercial divinylbenzene qualities which, in addition to the isomers of divinylbenzene, also contain ethylvinylbenzene, are sufficient. Mixtures of different crosslinkers, e.g. mixtures of divinylbenzene and divinyl ether, can also be used.

In process step b), the encapsulated bead-type monomer drops are admixed with (meth)acrylic monomers, suitable crosslinkers, initiators and, where appropriate, porogens.

(Meth)acrylic monomers in the present context are preferably taken to mean (meth)acrylic esters, (meth)acrylamides, (meth)acrylonitrile, acrylic acid, methacrylic acid, acryloyl chloride or methacryloyl chloride alone or in a mixture. (Meth)acrylamides are preferably taken to mean substituted and unsubstituted amides of acrylic acid and methacrylic acid. Use is most preferably made of acrylamide, methacrylamide, dimethylacrylamide, dimethylmethacrylamide, diethylacrylamide or diethylmethacrylamide. Most preference is given to acrylamide and methacrylamide. (Meth)acrylonitrile comprises acrylonitrile and methacrylonitrile. Particularly preferably, use is made of acrylonitrile and methyl acrylate in the context of the present invention.

Crosslinkers in process step b) in the context of the present invention are the crosslinkers already described under process step a).

The fraction of crosslinker in the total amount of monomers formed from encapsulated monomer drops and metered monomer mixture is preferably 2 to 50% by weight, particularly preferably 4 to 20% by weight, most particularly preferably 4 to 10% by weight.

Initiators which are suitable for the inventive process are preferably peroxy compounds such as dibenzoyl peroxide, dilauroyl peroxide, bis(p-chlorobenzoyl) peroxide, dicyclohexyl peroxy-dicarbonate, tert-butyl peroctoate, tert-butyl peroxy-2-ethylhexanoate, 2,5-bis(2-ethyl-hexanoylperoxy)-2,5-dimethylhexane or tert-amylperoxy-2-ethylhexane, and also azo compounds such as 2,2′-azobis(isobutyronitrile) or 2,2′-azobis(2-methylisobutyronitrile).

The initiators are preferably used in amounts of 0.05 to 2.5% by weight, particularly preferably 0.1 to 1.5% by weight, based on the monomer mixture.

As further additives in the monomer mixture or the encapsulated monomer drops of monoethylenically unsaturated compounds, suitable crosslinkers and initiators, use can be made of porogens in order to generate a macroporous structure in the bead-type polymer. Organic solvents which mix with the monoethylenically unsaturated compounds (meth)acrylic monomers are suitable for this. Hexane, cyclohexane, octane, isooctane, isododecane, methyl ethyl ketone, methyl isobutyl ketone, n-butanol-2-butanol, isobutanol, tert-butanol, octanol or methylisobutylcarbinol are preferably used alone or in a mixture. Suitable porogens are also described in DE-A1 045 102, DE-A 1 113 570 and U.S. Pat. No. 4,382,124.

The porogen fraction used for the synthesis of inventive macroporous cation exchangers is 3 to 200% by weight, preferably 5 to 20% by weight, based on the monomer mixture. The porogen, for the synthesis of macroporous bead polymers, may be added either before or during polymerization.

The terms macroporous and gel-type have been described in detail in the specialist literature, for example in Seidl, Malinsky, Dusek, Heitz, Adv. Polymer Sci., Vol. 5 pages 113 to 213 (1967).

Addition of the monomer feed to the encapsulated monomer drops in process step b) can also be performed in such a manner that an aqueous emulsion of the monomer feed is added to an aqueous dispersion of the encapsulated monomer drops. Finely divided emulsions having median particle sizes of 1 to 10 μm are highly suitable, which can be produced using rotor-stator mixers, mixer-jet nozzles or ultrasonic dispersion units using emulsifying aids, such as, for example, sulphosuccinic isooctyl ester sodium salt.

In process step c), the monodisperse (meth)acrylic bead polymers are produced at elevated temperature by polymerization of the corresponding monomer mixture in an aqueous phase. For the purposes of the present invention, elevated temperatures are 50-140° C., preferably 60-135° C.

In this case, in an alternative embodiment, the aqueous phase can contain a dissolved polymerization inhibitor. Inhibitors which come into consideration are not only inorganic but also organic substances. Preferred inorganic inhibitors are nitrogen compounds, such as hydroxylamine, hydrazine, sodium nitrite, potassium nitrite, salts of phosphorous acid, such as sodium hydrogenphosphite, and sulphur compounds, such as sodium dithionite, sodium thiosulphate, sodium sulphite, sodium bisulphite, sodium thiocyanate or ammonium thiocyanate. Preferred organic inhibitors are phenolic compounds, such as hydroquinone, hydroquinone monomethyl ether, resorcinol, catechol, tert-butylcatechol, pyrogallol or condensation products of phenols with aldehydes. Other preferred organic inhibitors are nitrogen compounds. These include hydroxylamine derivatives, for example N,N-diethylhydroxylamine, N-isopropylhydroxylamine and sulphonated or carboxylated N-alkylhydroxylamine derivatives or N,N-dialkylhydroxylamine derivatives, hydrazine derivatives, for example N,N-hydrazinodiacetic acid, nitroso compounds, for example N-nitrosophenylhydroxylamine, N-nitrosophenylhydroxylamine ammonium salt or N-nitrosophenylhydroxylamine aluminium salt. The concentration of the inhibitor is preferably 5 to 1000 ppm (based on the aqueous phase), particularly preferably 10 to 500 ppm, most particularly preferably 10 to 250 ppm.

The monomer mixture is polymerized optionally in the presence of one or more protective colloids in the aqueous phase. Protective colloids used are preferably natural or synthetic water-soluble polymers, for example gelatin, starch, polyvinyl alcohol, polyvinylpyrrolidone, polyacrylic acid, polymethacrylic acid, or copolymers of (meth)acrylic acid and (meth)acrylic esters. Very highly suitable protective colloids are also cellulose derivatives, in particular cellulose esters and cellulose ethers, such as carboxymethylcellulose, methylhydroxyethylcellulose, methylhydroxypropylcellulose and hydroxyethylcellulose. Gelatin or methylhydroxyethylcellulose are particularly preferred. The amount of protective colloids used is preferably 0.05 to 1% by weight, based on the aqueous phase, particularly preferably 0.05 to 0.5% by weight.

The polymerization to give the monodisperse crosslinked (meth)acrylic polymer can optionally also be carried out in the presence of a buffer system. Preference is given to buffer systems which set the pH of the aqueous phase at the start of polymerization to between 14 and 6, particularly preferably between 13 and 8. Under these conditions protective colloids containing carboxylic acid groups are present wholly or partly as salts. In this manner the action of the protective colloids is favourably influenced. Particularly highly suitable buffer systems comprise phosphate salts or borate salts. The terms phosphate and borate in the context of the invention also include the condensation products of ortho forms of corresponding acids and salts. The concentration of phosphate or borate in the aqueous phase is 0.5 to 500 mmol/l, preferably 2.5 to 100 mmol/l.

The stirrer speed in the polymerization is less critical and, in contrast to the conventional bead polymerization, has barely any effect on the particle size. Low stirrer speeds are employed which are sufficient to keep the suspended monomer droplets in suspension and to support the removal of the heat of polymerization. For this task, various stirrer types can be used. Particularly suitable types are gate stirrers having an axial action.

The volumetric ratio of the sum of seed-bead polymer and monomer mixture to aqueous phase is 1:0.75 to 1:20, preferably 1:1 to 1:6.

The polymerization temperature depends on the decomposition temperature of the initiator used. It is preferably between 50 and 180° C., particularly preferably between 55 and 130° C. The polymerization takes 0.5 h to a few hours. It has proven useful to employ a temperature programme in which the polymerization is started at low temperature, for example 60° C., and the reaction temperature is increased with advancing conversion of polymerization. In this manner, for example, the demand for a safe reaction and a high degree of polymerization can be fulfilled very efficiently. After polymerization the bead polymer is isolated with conventional methods, for example by filtration or decanting, and, if appropriate, washed.

Another embodiment of the present invention is a multistage feed process corresponding to process step d). In this process the (meth)acrylic polymer is produced in a plurality of individual steps. For example, an aqueous suspension of encapsulated monomer drops based on styrene-divinylbenzene is produced, this is admixed with a first mixture of (meth)acrylic monomers, crosslinker and initiator and polymerized, the copolymer I being obtained. Copolymer I is admixed with further monomer mixture of (meth)acrylic monomers, crosslinker and initiator and polymerized, the inventive monodisperse crosslinked (meth)acrylic bead polymer being formed. “Admixing in the context of the present invention means “feeding” which is why the word “fed” may also be used instead of “added”. We can therefore speak of a seed/feed process.

The mean particle size of the crosslinked (meth)acrylic bead polymers from process step c) is 10-1000 μm, preferably 100-1000 μm, particularly preferably 200 to 800 μm.

In process step d) of the inventive process, the monodisperse crosslinked (meth)acrylic bead polymer from process step c) is hydrolysed.

Suitable hydrolysis agents in this process are strong bases or strong acids, for example sodium hydroxide solution or sulphuric acid. The concentration of the hydrolysis agent is preferably 5 to 50% by weight. The hydrolysis preferably proceeds at temperatures of 50° C. to 200° C., particularly preferably 80° C. to 180° C. The duration of the hydrolysis is preferably 1 to 24 h, particularly preferably 1 to 12 h.

After hydrolysis the reaction mixture of hydrolysis product and residual hydrolysis agent is cooled to room temperature and first diluted with water and washed.

When sodium hydroxide solution is used as hydrolysis agent, the weakly acidic cation exchanger arises in the sodium form. For some applications it is expedient to convert the cation exchanger from the sodium form to the acid form. This exchange is done preferably with mineral acids such as hydrochloric acid or with sulphuric acid of a concentration of 5 to 50% by weight, preferably 10 to 20% by weight.

If desired, the weakly acidic cation exchanger obtained according to the invention, for purification, is treated with water or steam at temperatures of 70 to 180° C., preferably 105 to 150° C.

The present invention also relates to the monodisperse cation exchanger of the poly(meth)acrylic acid type obtainable by
a) preparing encapsulated, bead-type monomer drops in a continuous, preferably aqueous phase and this phase is heated, where appropriate to temperatures ≧50° C.,
b) admixing these encapsulated bead-type monomer drops with mixtures of (meth)acrylic monomers, suitable crosslinkers, initiators and optionally porogens, optionally under polymerization conditions, the mixture penetrating into the encapsulated drops and optionally copolymerizing,
c) polymerizing the encapsulated drops at elevated temperature, and
d) hydrolysing the resultant, monodisperse, crosslinked (meth)acrylic bead polymer with acids or alkalis to give a crosslinked monodisperse bead polymer of the (meth)acrylic acid-type.

Surprisingly, the inventive monodisperse cation exchangers have a particular osmotic and mechanical stability. Owing to this beneficial property and the monodispersity, these cation exchangers are suitable for numerous applications.

The present invention therefore also relates to the use of the inventive monodisperse cation exchanger of the poly(meth)acrylic acid type
for removing cations, dye particles or organic components from aqueous or organic solutions,
for softening in the neutral exchange of aqueous or organic solutions,
for purifying and workup of waters of the chemicals industry, the electronics industry and from power stations,
for separating off and purifying biologically active components, such as e.g. antibiotics, enzymes, peptides and nucleic acids from their solutions, for example from reaction mixtures and from fermentation broths.

In addition, the inventive cation exchangers can be used in combination with gel-type and/or macroporous anion exchangers for demineralizing aqueous solutions and/or condensates, in particular in drinking water treatment.

The present invention also relates to
processes for purifying and workup of waters of the chemicals industry, the electronics industry and from power stations,
processes for removing cations, dye particles or organic components from aqueous or organic solutions,
processes for softening in the neutral exchange of aqueous or organic solutions,
processes for separating off and purifying biologically active components, such as e.g. antibiotics, enzymes, peptides and nucleic acids from their solutions, for example from reaction mixtures and from fermentation broths
   using the inventive cation exchangers of the poly(meth)acrylic acid type.

The crosslinked macroporous monodisperse (meth)acrylic bead polymers obtainable from step c) as supports for enzymes, and the use of the system obtained therefrom as enzyme catalyst are novel and, furthermore, subject matter of the present invention.

The present invention therefore relates to the use of the crosslinked, macroporous, monodisperse (meth)acrylic bead polymers as enzyme supports and also the use of this system as an enzyme catalyst.

As already described above, monodisperse, macroporous, crosslinked, bead-type bead polymers based on (meth)acrylic esters can be produced by the in situ seed/feed process in step b). If, in production thereof, encapsulating mix is used which contains a monomer mixture of styrene, divinylbenzene, porogen and initiator, after feed with the further monomer mixture under polymerizing conditions, a monodisperse, macroporous, crosslinked bead polymer is formed which has, for example, the following composition:

20 parts DVB 100% pure

4 parts ethylstyrene

14 parts styrene

60 parts methyl methacrylate

20 parts n-butyl methacrylate

For this, use is preferably made of encapsulating mix based on styrene, divinylbenzene and porogen, since encapsulating mix based on (meth)acrylic esters/porogen/crosslinker alone is not currently available.

The resultant bead polymers can also be used as supports for enzymes. As supports for enzymes, use is preferably made of those bead polymers which are produced based on mixtures of (meth)acrylic esters, optionally with addition of acrylic esters.

Preferably, use is made of mixtures of methyl methacrylate with n-butyl methacrylate or n-hexyl methacrylate or 2-ethylhexyl methacrylate.

As crosslinkers, porogens and also other polymerization substances, the abovementioned substances are used.

After production (polymerization) of the macroporous, monodisperse bead polymer, this is freed from the residual amounts of porogen present in the beads by distillation. The porogen can also be removed by other processes such as elution of the bead polymer with alcohols, preferably methanol, propanol, isopropanol or other alcohols, or else by steam distillation.

The said macroporous, monodisperse bead polymers based on crosslinked (meth)acrylic esters can be used as a base (support) for enzymes. The resultant (immobilized) enzyme-loaded bead polymer can be used as catalyst for esterification reactions and transesterification reactions. For instance, for example terpene alcohol esters which are used as fragrances, are produced by reaction of terpene alcohols such as geraniol, L-menthol, phytol or linalool with acids such as acetic acid, propionic acid, n-butyric acid using Aspergillus niger lipase as catalyst. From glycerides and fatty acids, in this manner, using lipases as catalyst, glycerides of fatty acids are produced.

Ester syntheses using enzymes can be carried out at temperatures between room temperature and up to approximately 80° C. in the physiological environment at atmospheric pressure. A multiplicity of enzymes can be used as catalyst. In particular, use is made of enzymes of the class of hydrolases, which includes the group of lipases. The enzymes can be lipases of animal, vegetable or microbial origin. These include lipases of the organisms Thizomucor, Humicolar or Candida rugosa.

The enzymes can be immobilized on the bead polymer of the invention (support) by adsorption or by the enzyme, by reaction with glutardialdehyde or other crosslinkers, being crosslinked with itself and the support and as a result being bound to the support.

The esterification (transesterification) reactions can proceed with stirring in the batch, or else in a column process, wherein the reactants are continuously passed through the enzyme immobilized on supports in the column.

Currently, novel processes are being developed internationally as alternatives for fuels and automotive petroleum. Biodiesel is also included. Biodiesel is the methyl ester of longer-chain fatty acids. This is obtained by a transesterification reaction of the glycerol ester of fatty acids obtained from plants with methanol. As catalyst of this reaction, use is made of sodium hydroxide solution.

Starting materials of the biodiesel are oils of vegetable origin, for example rapeseed oil. Rapeseed oil is a mixture of the glycerol esters of various fatty acids such as palmitic, stearic, oleic, linoleic and erucic acids.

It has been found, that instead of the catalyst sodium hydroxide solution for the transesterification reaction of the glycerol esters of fatty acids with methanol to give biodiesel, use can be made of an enzyme catalyst based on monodisperse, macroporous, bead polymers of the invention, based on crosslinked (meth)acrylic esters.

The present invention therefore also relates to the use of monodisperse, macroporous bead polymers based on crosslinked (meth)acrylic esters in the production of fuels, preferably automotive petroleum or biodiesel, and also in esterification reactions and transesterification reactions.

### EXAMPLES

### Example 1

### According to In Situ Seed/Feed Process

Process Steps a-c)

### 1a) Production of a Copolymer Containing 80% by Weight Acrylonitrile Units—DVB is Metered in as Emulsion

In a 4 l glass reactor, 103.4 g of demineralized water and 53.6 g of an aqueous solution which contains, dissolved, 1.8 g of gelatin, 0.91 g of disodium hydrogenphosphate and 0.134 g of resorcinol, were charged. To this were added successively 21.86 gram of acrylonitrile and 333.8 g of demineralized water at room temperature.

To this initial charge were added 627.9 g of aqueous monodisperse encapsulating mix dispersion the 195 g of monodisperse microencapsulated monomer drops containing 113.4 g of styrene, 7.58 g of technical divinylbenzene 80.0% pure, 64 g of isododecane and 0.75 g of Trigonox® 21 s.

The dispersion was blanketed with nitrogen. In 2 hours, the dispersion was heated to 73° C. and it was stirred for a further 8 hours at this temperature. After stirring for 30 minutes at 73° C., in the course of a further 6 hours, two feeds were metered in simultaneously.

Feed 1 consisted of 706.7 g of acrylonitrile.

Feed 2 consisted of 47.8 g of divinylbenzene (DVB) 80% pure, 71.8 g of demineralized water and 0.24 g of Aerosol OT. The dispersion was dispersed with an ultratorax and then diluted with a further 759 g of demineralized water. The entire solution was metered in.

After metering in was completed, the mixture was heated in one hour to 95° C. and stirred for a further 2 hours at 95° C.

Divinylbenzene was used as commercially conventional isomeric mixture of 80.0% by weight divinylbenzene and 20.0% by weight ethylstyrene.

The monodisperse microencapsulated monomer drops were produced according to EP 0 046 535 A1 and the capsule wall of the seed polymer consisted of a formaldehyde-cured complex coacervate of gelatin and an acrylamide/acrylic acid copolymer. The median particle size of the microencapsulated monomer drops was 450 μm.

The mixture was stirred with a stirrer speed of 220 rpm. The batch, after cooling, was washed over a 100 μm sieve using demineralized water and then dried for 18 hours at 80° C. in the drying cabinet. This produced 898.5 g of a spherical copolymer I having a median particle size of 585 μm.

The nitrogen content of the bead polymer was 18.75% by weight.

A content of 80.1% by weight acrylonitrile units in the crosslinked copolymer is calculated therefrom.

### 1b) Reaction of the Acrylonitrile-containing Copolymer to Give a Weakly Acidic Cation Exchanger

Apparatus: 6 l pressure reactor having pressure-retaining valve, agitator, thermostat, pump

1800 ml of demineralized water and 500 g of crosslinked copolymer from 1a) were charged in the reactor. The suspension was heated to 150° C. In 2 hours, 135 ml of 50% strength by weight sodium hydroxide solution were metered in. Subsequently, in 1¼ hours, a further 708 ml of 50% strength by weight sodium hydroxide solution were metered in. Thereafter, the mixture was stirred for a further 6 hours at 150° C. The batch was cooled. The saponified polymer was drained off and washed alkali-free with demineralized water on the vacuum filter.

Volume yield: 1980 ml

The resin was transferred to a column. From the top, 10 litres of 4% strength by weight aqueous sulphuric acid were filtered through in 4 hours. Subsequently, the resin was washed sulphuric acid-free with demineralized water.

Volume yield: 1220 ml

Total capacity: 5.16 mol/l

Elemental composition:

Carbon: 60.0% by weight

Hydrogen: 6.4% by weight

Oxygen: 32.5% by weight

Residual nitrogen: 1.1% by weight

Original stability: 99% whole beads

Swelling stability: 98% whole beads

Injection stability: 99% whole beads

Roll stability: 98% whole beads

Median bead diameter: 0.82 mm

### 1c) Cleaning the Weakly Acidic Cation Exchanger in the Autoclave by Steam

1165 ml of demineralized water and 1165 ml of weakly acidic cation exchanger in the hydrogen form were charged in the autoclave. The batch was heated to 150° C. and stirred for a further 5 hours at this temperature. Then, the water was forced out of the autoclave via a frit tube and replaced by the same amount of fresh water. The mixture was stirred for a further 5 hours at 150° C.

This cleaning was repeated three times.

The autoclave was cooled. The resin was washed with demineralized water on a sieve.

Resin volume: 1100 ml

### Example 2

### By In Situ Seed/Feed Process

### 2a ) Production of a Copolymer Containing 70% by Weight Acrylonitrile Units—DVB is Metered in in the Acrylonitrile Phase

103.4 g of demineralized water and 53.6 g of an aqueous solution which contained, dissolved, 1.8 g of gelatin, 0.91 g of disodium hydrogenphosphate and 0.134 g of resorcinol are charged in a 4 l glass reactor. To this are metered in successively at room temperature 16.12 grams of acrylonitrile and 333.8 g of demineralized water.

To this charge were added 627.9 g of aqueous monodisperse encapsulating mixed dispersion of 195 g of monodisperse microencapsulated monomer drops containing 113.4 g of styrene, 7.58 g of technical divinylbenzene 80.0% pure, 64 g of isododecane and 0.75 g of Trigonox® 21 S.

The dispersion was blanketed with nitrogen. The dispersion was heated to 73° C. in 2 hours and stirred for a further 8 hours at this temperature. After stirring for 30 minutes at 73° C., in the course of a further 6 hours, a mixture of 521.25 g of acylonitrile and 35.3 g of DVB 81.1% pure by weight were metered in thereto.

After the completion of metering, the mixture was heated to 80° C. in one hour and stirred for a further hour at 80° C. Subsequently, the mixture was heated to 95° C. and stirred for a further 2 hours at 95° C.

Divinylbenzene was used as commercially conventional isomer mixture of 81.1% by weight divinylbenzene and 18.9% by weight ethylstyrene.

The monodisperse microencapsulated monomer drops were produced according to EP 0 046 535 A2 and the capsule wall of the seed polymer consisted of a formaldehyde-cured complex coacervate of gelatin and an acrylamide/acrylic acid copolymer. The median particle size of the microencapsulated monomer drops was 450 μm.

The mixture was stirred at a stirrer speed of 220 rpm. The batch, after cooling, was washed over a 100 μm sieve with demineralized water and then dried for 18 hours at 80° C. in the drying cabinet. This produced 701.7 g of a spherical copolymer having a median particle size of 557 μm.

The nitrogen content of the bead polymer was 17.70% by weight.

A content of 67.05% by weight acrylonitrile units in the crosslinked copolymer is calculated therefrom.

### 2b) Reaction of the Acrylonitrile-containing Copolymer to Give a Weakly Acidic Cation Exchanger

Apparatus: 6 l pressure reactor having pressure-retaining valve, stirrer, thermostat, pump

1800 ml of demineralized water and 500 g of crosslinked copolymer from 2a) were charged in the reactor. The suspension was heated to 150° C. In 2 hours, 127 ml of 50% strength by weight sodium hydroxide solution were metered in. Subsequently, in 1.15 hours, a further 666 ml of 50% strength by weight sodium hydroxide solution were metered in. Thereafter, the mixture was stirred at 150° C. for a further 6 hours. The batch was cooled. The saponified polymer was drained and washed alkali-free with demineralized water on the vacuum filter.

Volume yield: 2000 ml

The resin was transferred into a column. From the top, 10 litres of 4% strength by weight aqueous sulphuric acid were filtered through in 4 hours. Subsequently, the resin was washed sulphuric acid-free with demineralized water.

Volume yield: 1280 ml

Total capacity: 3.41 mol/l

Elemental composition:

Carbon: 61.9% by weight

Hydrogen: 6.4% by weight

Oxygen: 30.4% by weight

Residual nitrogen: 1.1% by weight

Original stability: 99% whole beads

Swelling stability: 99% whole beads

Injection stability: 99% whole beads

Roll stability: 99% whole beads

Median bead diameter: 0.76 mm

### 2c) Cleaning the Weakly Acidic Cation Exchanger in the Autoclave by Steam

1225 ml of demineralized water and 1225 ml of weakly acidic cation exchanger in the hydrogen form were charged in the autoclave. The batch was heated to 150° C. and stirred at this temperature for a further 5 hours. Then the water was forced from the autoclave via a frit tube and replaced by the same amount of fresh water. The mixture was stirred for a further 5 hours at 150° C.

This cleaning was repeated three times.

The autoclave was cooled. The resin was washed on a sieve with demineralized water.

Resin volume: 1160 ml

Total capacity: 3.54 mol/l

### Methods of Investigation:

### Determination of the Total Capacity of the Resin

In a 100 ml measuring cylinder, 55 ml of exchanger in the delivery form were shaken under demineralized water on a vibrating bench and were flushed into a filter tube. 300 ml of 15% strength hydrochloric acid were metered in in the course of 60 minutes. Subsequently, the resin was washed with demineralized water until the eluate was neutral. 50 ml of the resin were vibrated and flushed into a filter tube. 600 ml of 1 n sodium hydroxide solution were metered in in the course of 60 minutes and the eluate was collected in a 1 litre Erlenmeyer flask. The resin was washed with 200 ml of demineralized water, wherein the eluate was likewise collected in the 1 litre Erlenmeyer flask. The Erlenmeyer flask was made up to the mark with demineralized water and mixed. 50 ml of solution were diluted in a glass beaker with 50 ml of demineralized water and titrated with 0.1 n hydrochloric acid to pH 4.3 using a pH electrode.

Total capacity (TC): the total capacity is a measure of the amount of acid groups in the resin.

Dimension: mol of acid groups per litre of resin

Determination of TC

(30−consumption)/2.5=mol/litre of resin in the acid form

Demineralized water, for the purposes of the present invention, is characterized by having a conductivity of 0.1 to 10 μS, wherein the content of dissolved or undissolved metal ions is not greater than 1 ppm, preferably not greater than 0.5 ppm, for Fe, Co, Ni, Mo, Cr, Cu as individual components and not greater than 10 ppm, preferably not greater than 1 ppm, for the sum of the said metals.

What is claimed is:

1. A process for producing cation exchangers of the poly(meth)acrylic acid type, wherein
a) encapsulated, bead-type monomer drops are prepared in a continuous preferably aqueous phase and this phase is heated, where appropriate, to temperatures ≧50° C.,
b) these encapsulated bead-type monomer drops are admixed with mixtures of (meth)acrylic monomers, crosslinkers, initiators and optionally porogens, optionally under polymerization conditions, the mixtures penetrating into the encapsulated drops and, in the case of addition, under polymerization conditions is copolymerized
c) the encapsulated drops are polymerized at elevated temperature,
d) the resultant crosslinked (meth)acrylic bead polymer is hydrolysed with acids or alkalis to give a crosslinked bead polymer of the poly(meth)acrylic acid type.

2. A process according to claim 1, wherein steps b) and c) are repeated once or repeatedly.

3. A process according to claim 1, wherein the monomer drops to be used in process step a) are used in monodisperse form and crosslinked monodisperse bead polymers of the poly(meth)acrylic acid type are obtained.

4. A process according to claim 3, wherein the monodisperse, bead-type encapsulated monomer drops prepared in process step a) are generated by a combination of jetting and/or oscillation excitation and microencapsulation.

5. A process according to claim 3, wherein the monodisperse bead-type monomer drops are microencapsulated by a complex coacervate.

6. A process according to claim 1, wherein the bead-type encapsulated monomer drops contain styrene and divinylbenzene.

7. A process according to claim 1 wherein (meth)acrylate, (meth)acrylamide, (meth)acrylonitrile, acrylic acid, methacrylic acid, aryloyl chloride, methacryloyl chloride, alone or in a mixture is used as (meth)acrylic monomer.

8. A process according to claim 1, wherein multifunctional ethylenically unsaturated compounds are used as crosslinkers.

9. A process according to claim 1, wherein methyl isobutyl ketone, hexane, cyclohexane, octane, isooctane, isododecane, n-butanol, 2-butanol, isobutanol, t-butanol, octanol, alone or in a mixture are used as porogen.

10. A monodisperse cation exchanger of the poly(meth)acrylic acid type obtained according to claim 1, wherein the ratio of the 90% value (Ø(90)) and the 10% value (Ø(10)) of the volume distribution, Ø(90)/Ø(10), is less than or equal to 1.25.

11. A method of using monodisperse cation exchangers of the poly(meth)acrylic acid type according to claim 10
for removing cations, dye particles or organic components from aqueous or organic solutions,
for softening in the neutral exchange of aqueous or organic solutions,
for purifying and workup of waters of the chemicals industry, the electronics industry and from power stations,
for decolorizing and desalting of wheys, thin gelatin broths, fruit juices, fruit musts and aqueous solutions of sugars,
for separating off and purifying biologically active components, such as e.g. antibiotics, enzymes, peptides and nucleic acids from their solutions.

12. A method of using crosslinked, macroporous, monodisperse (meth)acrylic bead polymers from step c) in claim 1 as supports for enzymes and of the system obtained therefrom as enzyme catalyst.

13. A method of using the enzyme catalyst from claim 12 in the production of fuels and also in esterification reactions and transesterification reactions.

14. A method of use according to claim 13, wherein the fuels are automotive petroleum or biodiesel.
